(19) United States
(12) Patent Application Publication
(10) Pub. No.: US 2005/0071656 A1
(43) Pub. Date: Mar. 31, 2005

(54) Secure processor-based system and method

(76) Inventors: Dean A. Klein, Eagle, ID (US); Neal A. Crook, Reading (GB)

Correspondence Address: EDWARD W. BULCHIS, Esq.;DORSEY & WHITNEY LLP, Suite 3400, 1420 Fifth Avenue, Seattle, WA, 98101, US

(21) Appl. No.: 10/672,956

(22) Filed: Sep. 25, 2003

(51) Int. Cl. H04L 9/32

(52) U.S. Cl. 713/193

(57) ABSTRACT

A computer system includes a central processor unit (“CPU”), a dynamic random access memory (“DRAM”) device, a key storage device storing a decryption key, a decryption engine and a system controller coupling the CPU to the DRAM. All of these components are fabricated on a common integrated circuit substrate so that interconnections between these components are protected from unauthorized access. The system controller is also coupled through to a non-volatile memory that stores a computer program that has been encrypted. In operation, the computer program is transferred through the system controller to the decryption engine, which uses the decryption key to decrypt the computer program. The CPU executes the encrypted program, and, in doing so, transfers data between the CPU and the system memory. This data is protected from unauthorized access because the connections between the CPU and the system memory are internal to the integrated circuit.

### TECHNICAL FIELD

This invention relates to processor-based electronic devices such as computer systems, and, more particularly, to a processor-based electronic device and method that can execute a program to process data without allowing unauthorized access to either the program or the data.

### BACKGROUND OF THE INVENTION

Digital content in the form of both programs and data is becoming increasing valuable, thus increasing the importance of protecting such digital content from unauthorized access for copying or other use. Most computer systems provide only limited security for a variety of reasons.

A portion of a typical computer system 10 is shown in FIG. 1. The computer system 10 includes a central processing unit (“CPU”) 14 having a processor bus 18, which generally includes a data bus 20, an address bus 24 and a control/status bus 28. The processor bus 18 is coupled to a system controller 30 that is, in turn, coupled to a dynamic random access memory (“DRAM”) device 34, which serves as system memory, and to an expansion bus 36. The expansion bus is coupled to a number of peripheral devices including an input device 38, an output device 40 and a mass storage device 44, such as a disk drive. The expansion bus is also coupled to a flash memory device 50. The DRAM device 34 normally serves as system memory, and the flash memory device 50 normally serves as a program memory by storing all or a part of a program executed by the CPU 14. For example, the flash memory device 50 may store only a basic input/output system (“BIOS”) program, or it may store one or more applications programs. Application programs may also be stored in the mass storage device 44. The computer system 10 normally includes several additional components, but these have been omitted from FIG. 1 in the interest of brevity and clarity.

All of the above-described components are normally mounted on a substrate, such as a printed circuit board, and are coupled to each other by conductors (not shown). Generally, the conductors and/or integrated circuit terminals (not shown) attached to the conductors are accessible to anyone who has physical access to the computer system 10.

In operation, the processor attempts to protect from discovery the data coupled between the CPU 14 and the DRAM device 34 by encrypting write data as the data are sent to the DRAM device 34 and decrypting read data as the data are received from the DRAM device 34. This is generally accomplished by the CPU 14 reading an encryption/decryption key from the flash memory device 50, and the CPU 14 executing an algorithm using the key to encrypt and decrypt the data sent to or received from the DRAM device 34. Unfortunately, the computer system 10 shown in FIG. 1 and other conventional computer systems using similar architectures do not provide adequate performance for at least two reasons. First, since the system 10 protects only data sent to or received from the DRAM device 34, the system 10 fails to prevent access to the program stored in the flash memory device 50. Thus, the system fails to protect the program executed by the CPU 14 from unauthorized access. Second, encoding or decoding data each time the data is sent to or received from the DRAM device 34 requires a significant amount of time and can therefore reduce the data bandwidth between the CPU 14 and the DRAM device 34. Therefore, the encryption/decryption approach embodied in the computer system 10 of FIG. 1 generally functions well only for well defined encryption algorithms where only a moderate data bandwidth is required.

FIG. 2 is a block diagram of a computer system 70 showing another conventional technique to provide computer security. The computer system 70 includes many of the same components that are used in the computer system 10 of FIG. 1. The computer system 70 differs from the computer system 10 by including a non-volatile memory 74 fabricated on a common substrate 76 with the CPU 14. The non-volatile memory 74 memory may be any of a variety of conventional or hereafter developed memory devices including a flash memory device, a read only memory, a programmable read only memory, to name a few. The non-volatile memory 74 stores both programs executed by the CPU 14 and an encryption/decryption key that is used in the same manner as the encryption/decryption key stored in the flash memory device 50. By fabricating the CPU 14 and the device that stores programs executed by the CPU 14, i.e., the non-volatile memory 74, on the same integrated circuit substrate 76, the computer system 70 is able to protect the programs executed by the CPU 14 from unauthorized access, unlike the computer system 10 shown in FIG. 1. Using the key stored in the non-volatile memory 74, the CPU 14 encrypts the data coupled to the DRAM device 34 and decrypts the data received from the DRAM device 34 in substantially the same manner that the computer system 10 performs that function. Thus, while the computer system 70 has the advantage over the computer system 10 of protecting the programs executed by the CPU 14 from unauthorized access, it has the same disadvantage as the computer system 10 by limiting the data bandwidth between the CPU 14 and the DRAM device 34 because of the need to encrypt and decrypt data.

A major reason why conventional computer systems fail to provide adequate security is that their data buses between CPU and system memory are susceptible to unauthorized access. If access to the data bus between the CPU and the system memory could be prevented, it would be possible to adequately protect the data as well as programs executed by the CPU from the system memory. One technique to prevent unauthorized access to the data and programs stored in the system memory would be to fabricate the processor and system memory on the same substrate as a single integrated circuit. However, in the past, integration of a CPU and system memory has not been feasible.

A need therefore exists for a computer system and method for protecting data and programs stored in system memory from unauthorized access without reducing the data bandwidth between the CPU and system memory.

### SUMMARY OF THE INVENTION

A processor-based electronic device such as a computer system includes a central processing unit (“CPU”), a system memory device coupled to the CPU, and a decryption engine coupled to the CPU. The CPU, the system memory device and the decryption engine are housed in a common integrated circuit package so that interconnections between the CPU, the system memory device and the decryption engine are inaccessible from outside the package. The electronic device also includes a non-volatile memory device coupled to the decryption engine from outside the integrated circuit package. The non-volatile memory device stores a program in encrypted form. The encrypted program is decrypted by the decryption engine to allow the CPU to execute the program in unencrypted form.

### BRIEF DESCRIPTION OF THE DRAWINGS

FIG. 1 is a block diagram of a conventional computer system using one technique for preventing unauthorized access to data coupled between a CPU and system memory.

FIG. 2 is a block diagram of a conventional computer system using another technique for preventing unauthorized access to data coupled between a CPU and system memory.

FIG. 3 is a block diagram of a computer system according to one embodiment of the invention for preventing unauthorized access to data coupled between a CPU and system memory.

### DETAILED DESCRIPTION OF THE INVENTION

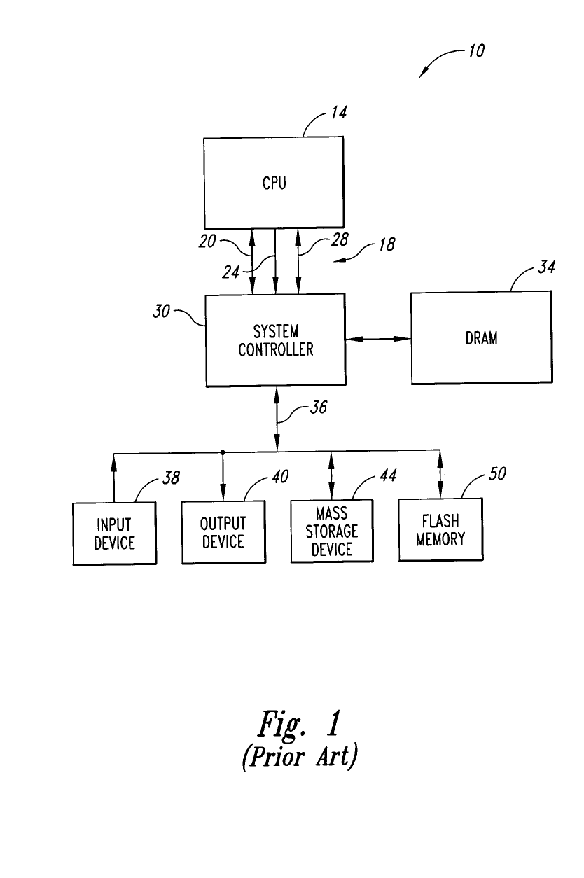

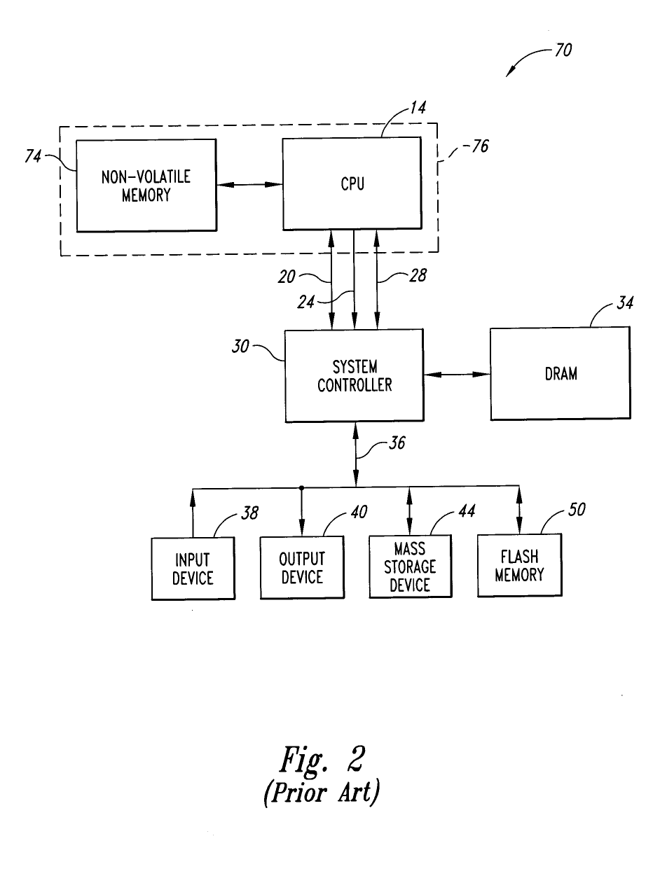

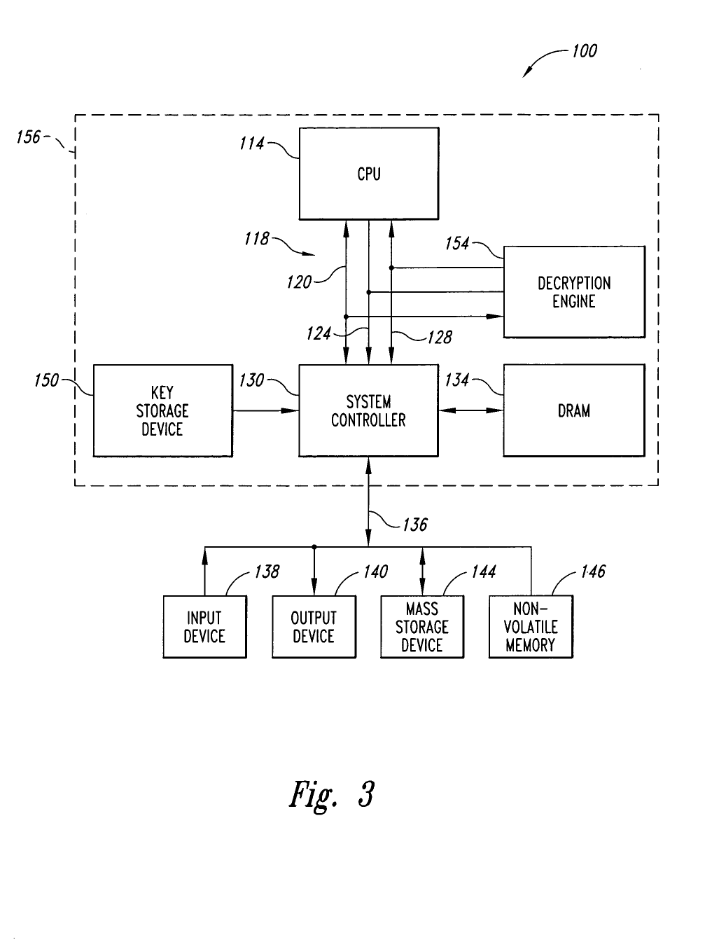

FIG. 3 shows a computer system 100 according to one embodiment of the invention. However, it will be understood that the invention may also be embodied in other types of processor-based electronic devices, such as embedded control systems, that also may be considered to be computer systems. For example, the computer system 100 or other processor-based electronic device may be part of a DVD player, MP3 player, microwave oven, automobile, etc. The computer system 100 includes a CPU 104 having a processor bus 118, which includes a data bus 120, an address bus 124 and a control/status bus 128. The processor bus 118 is coupled to a system controller 130 that is, in turn, coupled to a dynamic random access memory (“DRAM”) device 134, which serves as system memory. The processor bus 118 is also coupled to an expansion bus 136 through a system controller 138. The expansion bus 136 is, in turn, coupled to a number of peripheral devices including an input device 138, an output device 140, a mass storage device 144, such as a disk drive, and a non-volatile memory 146. Unlike the computer systems 10, 70 shown in FIGS. 1 and 2, respectively, the computer system 100 also includes a key storage device 150, which stores a decryption key, and a decryption engine 154. The key storage device 150 may be a set of fusible links, a flash memory device, a programmable read-only memory, or any conventional or hereafter developed device capable of storing sufficient data to serve as a decryption key. Similarly, although the non-volatile memory device 146 is preferably a flash memory device, other conventional or hereafter developed non-volatile memory devices may be used.

Significantly, the CPU 114, system controller 130, DRAM device 134, key storage device 150 and decryption engine 154 are all housed in a single package 156, and are preferably fabricated in a common substrate as a common integrated circuit. As a result, the data path between the CPU 114 and the DRAM device 134 is inaccessible through all but extraordinary means, thereby protecting the data coupled between the CPU 114 and the DRAM device 134. As a result, it is not necessary to encrypt or decrypt the data coupled between the CPU 114 and the DRAM device 134 for the data to be adequately protected. The data bandwidth between the CPU 114 and the DRAM device 134 is therefore not limited by the means for protecting the data as in the computer systems 10 and 70 in FIGS. 1 and 2, respectively.

The decryption engine 154 is used with the decryption key stored in the key storage device 150 to protect the programs executed by the CPU 114 from unauthorized access. More specifically, the programs executed by the CPU 114 are stored in the non-volatile memory device 146 in encrypted form. In operation, the CPU 114 reads the programs from the non-volatile memory device 146 by fetching the program code from the memory device 146 and passing the code to the decryption engine 154, which converts the program to unencrypted form for execution by the CPU 114. The CPU 114 may execute the programs directly from the non-volatile memory device 146, as explained above. Alternatively, the programs stored in the non-volatile memory device 146 may be “shadowed” by transferring the programs to the DRAM device 134 after the programs have been decrypted by the decryption engine 154. In such a case, the programs can be transferred to the DRAM device 134 under the control of a bootstrap program which can either be stored in encrypted form in non-volatile memory device 146, or can be stored in non-encrypted form in a low-capacity non-volatile memory (not shown), such as a ROM, that is packaged with the CPU 114. In either case, the function of the bootstrap program is to fetch and decrypt the programs and write the programs to the DRAM device 134. Alternatively, a hardware direct memory access device may be provided to fetch the programs from the non-volatile memory device 146 and pass the programs the DRAM device 134 after they have been decrypted. In such case, the CPU 114 is preferably held in a reset condition until the hardware engine has completed this task. The computer system 100 of FIG. 3 thus protects not only the data coupled between the CPU 114 and the DRAM device 134, it also protects the programs executed by the CPU 114.

As explained above, the decryption engine 154 is preferably a hardware device because of the higher data bandwidth of hardware decryption engines. However, the decryption engine may alternatively be a software encryption engine, such as by using the CPU 114 to perform a decryption algorithm using the decryption key stored in the key storage device 150. In such case, a low capacity non-volatile memory (not shown) such as a ROM is also packaged with the CPU 114 to act as bootstrap code for the CPU 114 until programs can be read from the non-volatile memory device 146 and then decrypted. Alternatively, the bootstrap code can be stored by other means, such as by storing the bootstrap code in the key storage device 150. Using a software decryption engine may be more feasible in the event the programs stored in the non-volatile memory device 146 are shadowed as explained above because execution of the programs will not be slowed by the need to decrypt the programs as they are executed.

Although the decryption engine 154 and key storage device 150 may be used to decrypt only those programs that are stored in the non-volatile memory device 146, it may also be used to decrypt or encrypt data or programs received from or transmitted to other components of the computer system, such as the mass storage device 144. Therefore, programs executed by the CPU 114 may be stored in the mass storage device 144 in encrypted form and executed by the CPU after the programs have been decrypted by the decryption engine 154, either directly or from the DRAM device 134 after being shadowed.

In operation, the decryption engine 154 is preferably programmed with the decryption key stored in the key storage device 150 at power-up of the computer system 100. Thereafter, one or more block of programs that will be executed by the CPU 114 are decrypted by the decryption engine 154 and transferred to the DRAM device 134 if the programs are to be shadowed. Otherwise encrypted program code is decrypted as it is executed by the CPU 114.

The decryption key stored in the key storage device 150 can be used with the decryption algorithm, whether implemented in hardware or software, using a variety of techniques. The decryption key can be the private key part of a public/private key pair. For example, the public key may be used for encryption by the publisher of an operating system program, and the private key stored in the key storage device 150 is then used for decryption. The private key cannot be derived from the public key, and the public key is kept secret, thus making the programs encrypted using the public key and then stored in the non-volatile memory device 146 secure. The public key may, for example, be disclosed only to a limited number of software developers who have executed a non-disclosure agreement to allow the software developers to encrypt their programs using the public key. The private key is disclosed to authorized users of the computer system 100, which may be accomplished using a variety of means. For example, the private key may be programmed into the key storage device 150 of each computer system 100 supplied by the manufacturer of the computer system 100, or it may be disclosed to authorized users of the computer system 100 to allow the user to program the key storage device 150.

The decryption key stored in the key storage device 150 can also by used in a symmetric cipher, which used the same key for encryption and decryption. For each OEM user of the computer system 100, the manufacturer of the system 100 assigns the key by programming the key into the key storage device 150. The key is also disclosed to others, such as software developers, so they can encrypt their programs using the key before storing the programs in the non-volatile memory device 146. Alternatively, programs could be disseminated to authorized users under controlled conditions, such as by requiring such users to execute an appropriate software license. The user would then encrypt the programs using the key and store the encrypted program in the non-volatile memory device 146.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A processor-based electronic device, comprising:
a central processing unit (“CPU”);
a system memory device coupled to the CPU;
a decryption engine coupled to the CPU, the decryption engine being operable to perform a decrypting function;
an integrated circuit package housing the CPU, the system memory device and the decryption engine so that interconnections between the CPU, the system memory device and the decryption engine are inaccessible from outside the package; and
a source of a program in encrypted form, the source being external to the integrated circuit package and being coupled to the decryption engine, the encrypted program being decrypted by the decryption engine to allow the CPU to execute the program in unencrypted form.

2. The electronic device of claim 1 wherein the CPU, the system memory device and the decryption engine are fabricated as an integrated circuit on a common semiconductor substrate.

3. The electronic device of claim 1 wherein the decryption engine comprises a hardware decryption engine.

4. The electronic device of claim 1 wherein the decryption engine comprises a software decryption engine.

5. The electronic device of claim 4 wherein the decryption engine comprises:
a key storage device storing a decryption key; and
a decryption program storage device storing a decryption program that is executed by the CPU using the decryption key stored in the key storage device to decrypt the encrypted program stored in the non-volatile memory device.

6. The electronic device of claim 1 wherein the system memory device comprises a dynamic random access memory device.

7. The electronic device of claim 1, further comprising a system controller coupled between the CPU and the system memory and between the CPU and the non-volatile memory device, the system controller being housed in the integrated circuit package.

8. The electronic device of claim 1 wherein the decryption engine comprises:
a key storage device storing a decryption key; and
a decryption engine unit using the decryption key stored in the key storage device to decrypt the encrypted program stored in the non-volatile memory device.

9. The electronic device of claim 1 wherein the source of a program in encrypted form comprises a non-volatile memory device coupled to the decryption engine from outside the integrated circuit package, the non-volatile memory device storing the program in encrypted form.

10. The electronic device of claim 9 wherein the non-volatile memory device comprises a read-only memory device.

11. The electronic device of claim 9 wherein the non-volatile memory device comprises a flash memory device.

12. The electronic device of claim 9 wherein the non-volatile memory device comprises a mass storage device.

13. A secure processor module, comprising:
a central processing unit (“CPU”);
a system memory device coupled to the CPU;
a decryption engine coupled to the CPU, the decryption engine being operable to perform a decrypting function; and
an integrated circuit package housing the CPU, the system memory device and the decryption engine so that interconnections between the CPU, the system memory device and the decryption engine are inaccessible from outside the package.

14. The secure processor module of claim 13 wherein the CPU, the system memory device and the decryption engine are fabricated as an integrated circuit on a common semiconductor substrate.

15. The secure processor module of claim 13 wherein the decryption engine comprises a hardware decryption engine.

16. The secure processor module of claim 13 wherein the decryption engine comprises a software decryption engine.

17. The secure processor module of claim 16 wherein the decryption engine comprises:
a key storage device storing a decryption key; and
a decryption program storage device storing a decryption program that is executed by the CPU using the decryption key stored in the key storage device.

18. The secure processor module of claim 13 wherein the system memory device comprises a dynamic random access memory device.

19. The secure processor module of claim 13, further comprising a system controller coupled between the CPU and the system memory and between the CPU and the non-volatile memory device, the system controller being housed in the integrated circuit package.

20. The secure processor module of claim 13 wherein the decryption engine comprises:
a key storage device storing a decryption key; and
a decryption engine unit using the decryption key stored in the key storage device to perform a decrypting function.

21. The secure processor module of claim 13 further comprising a data path coupled to the decryption engine from outside the integrated circuit package, the data path being adapted to couple a program in encrypted form to allow the decryption engine to decrypt the encrypted program thereby allowing the CPU to execute the program in decrypted form.

22. The secure processor module of claim 21 wherein the decryption engine is further operable to pass a request for the encrypted program through the data path.

23. A processor-based electronic device, comprising:
an integrated circuit package;
a CPU housed within the integrated circuit package;
a system memory device housed within the integrated circuit package;
an external interface circuit housed within the integrated circuit package;
a first plurality of conductors coupling the CPU to the system memory device and to the external interface circuit, the first plurality of conductors being housed within the integrated circuit package and being inaccessible from outside the integrated circuit package;
a second plurality of conductors coupled to the external interface circuit, at least some of the second plurality of conductors extending outside the integrated circuit package so that the conductors are accessible from outside the integrated circuit package; and
a source of a program in encrypted form, the source being external to the integrated circuit package and being coupled to at least some of the second plurality of conductors that extend outside the integrated circuit package.

24. The electronic device of claim 23 further comprising a non-volatile memory device located outside the integrated circuit package, the non-volatile memory device being coupled to at least some of the second plurality of conductors.

25. The electronic device of claim 24 wherein the non-volatile memory device stores a program that is executed by the CPU.

26. The electronic device of claim 23 wherein the CPU, the system memory device and the external interface circuit are fabricated as an integrated circuit on a common semiconductor substrate.

27. The electronic device of claim 23 wherein the external interface circuit comprises a system controller coupled between the CPU and the system memory.

28. The electronic device of claim 23 wherein the system memory device comprises a dynamic random access memory device.

29. The electronic device of claim 23 wherein the source of a program in encrypted form comprises a non-volatile memory device external to the integrated circuit package and coupled to at least some of the second plurality of conductors that extend outside the integrated circuit package.

30. A method of securely executing a computer program in a processor-based electronic device having a central processing unit (“CPU”), a system memory, and an external interface circuit, the method comprising:
encrypting a computer program that is to be executed by the CPU;
coupling the computer program to the external interface device;
decrypting the computer program after the computer program has been coupled to the external interface device, the computer program being shielded from access after being decrypted;
executing the decrypted computer program using the CPU; and
during the execution of the computer program, coupling data between the CPU and the system memory, the data being shielded from access while being coupled between the CPU and the system memory.

31. The method of claim 30 wherein the act of shielding the data from access while the data are being coupled between the CPU and the system memory comprises packaging the CPU and the system memory in the same integrated circuit package.

32. The method of claim 30 wherein the act of shielding the data from access while the data are being coupled between the CPU and the system memory comprises fabricating the CPU and the system memory in the same integrated circuit substrate.

33. The method of claim 30 wherein the act of decrypting the computer program after the computer program has been coupled to the external interface device comprises:
storing a decryption key in a key storage device;
coupling the decryption key from the key storage device to a decryption engine;
coupling the computer program from the external interface device to the decryption engine;
using the decryption engine to decrypt the computer program based on the decryption key.

34. The method of claim 33 wherein the act of shielding the computer program from access after the program is decrypted comprises packaging the CPU, the key storage device and the decryption engine in the same integrated circuit package.

35. The method of claim 33 wherein the act of shielding the computer program from access after the program is decrypted comprises fabricating the CPU, the key storage device and the decryption engine in the same integrated circuit substrate.

36. The method of claim 30 wherein the act of executing the decrypted computer program using the CPU comprises:
after being decrypted, storing the decrypted computer program in the system memory; and
using the CPU to execute the computer program stored in the system memory by transferring the computer program from the system memory to the CPU for execution by the CPU.

37. The method of claim 30 wherein the act of executing the decrypted computer program using the CPU comprises transferring the decrypted computer program to the CPU for execution by the CPU after each as each of a plurality of program instructions are transferred from the program storage device.

38. The method of claim 30 wherein the act of decrypting the computer program after the computer program has been coupled to the external interface device comprises using the CPU to execute a decryption program that decrypts the computer program transferred from the program storage device.

39. The method of claim 30 wherein the processor-based electronic device further comprises a program storage device, and wherein the act of coupling the computer program to the external interface device comprises:
storing the computer program in the program storage device; and
coupling the computer program from the program storage device to the external interface device.
